(19) United States
(12) Patent Application Publication
(10) Pub. No.: US 2001/0035596 A1
(43) Pub. Date: Nov. 1, 2001

(54) Increasing the elongation at break of moldings

(76) Inventors: Sabine Oepen, Ellerstadt (DE); Michael Breulmann, Mannheim (DE); Norbert Guntherberg, Speyer (DE); Wil Duijzings, Ludwigshafen (DE); Norbert Niessner, Friedelsheim (DE); Roelof Marissen, HS Born (NL)

Correspondence Address: Herbert B. Keil, KEIL & WEINKAUF, 1101 Connecticut Ave., N.W., Washington, DC, 20036, US

(21) Appl. No.: 09/825,956

(22) Filed: Apr. 5, 2001

(30) Foreign Application Priority Data
Apr. 1, 2000 (DE) 10017789.1

(51) Int. Cl. B29C 45/00; C08F 6/14

(52) U.S. Cl. 264/328.17; 525/316; 528/480; 528/502 A

(57) ABSTRACT

In a process for increasing the elongation at break of moldings made from thermoplastic molding compositions comprising, based on the total of the amounts of components A and B and, where appropriate, C and/or D, the entirety of which gives 100% by weight,

a: from 1 to 99% by weight of a particulate emulsion polymer with a glass transition temperature below 0° C. and with a median particle size of from 50 to 1000 nm, as component A,

b: from 1 to 99% by weight of at least one amorphous or semicrystalline polymer, as component B,

c: from 0 to 50% by weight of other thermoplastic polymers, as component C, and

d: from 0 to 50% by weight of fibrous or particulate fillers or mixtures of these, as component D,

that dispersion of component A obtained from an emulsion polymerization is filtered to remove coagulated material and then further processed to give the thermoplastic molding composition.

The present invention relates to a process for increasing the elongation at break of moldings made from thermoplastic molding compositions.

A wide variety of moldings is produced from thermoplastic molding compositions which comprise at least one matrix polymer and a rubbery polymer.

The best known molding composition of this type is ABS (acrylonitrile-butadiene-styrene copolymer). ASA (acrylate-styrene-acrylonitrile copolymer) has also been developed in order to increase lightfastness and weathering resistance (see DE-A-196 30 061, for example).

Moldings made from ABS or ASA have a balanced property profile. However, the elongation at break of ABS polymers in particular is not adequate for every industrial application.

It is an object of the present invention, therefore, to provide a process for increasing the elongation at break of moldings made from thermoplastic molding compositions, in particular made from ABS molding compositions or ASA molding compositions.

We have found that this object is achieved by means of a process for increasing the elongation at break of moldings made from thermoplastic molding compositions comprising, based on the total of the amounts of components A and B and, where appropriate C and/or D, the entirety of which gives 100% by weight,

a: from 1 to 99% by weight of a particulate emulsion polymer with a glass transition temperature below 0° C. and with a median particle size of from 50 to 1000 nm, as component A,

b: from 1 to 99% by weight of at least one amorphous or semicrystalline polymer, as component B,

c: from 0 to 50% by weight of other thermoplastic polymers, as component C, and

d: from 0 to 50% by weight of fibrous or particulate fillers or mixtures of these, as component D,

which comprises filtering that dispersion of component A obtained from an emulsion polymerization, to remove coagulated material, and then further processing the dispersion to give the thermoplastic molding composition.

According to the invention, it has been found that the elongation at break of moldings made from thermoplastic molding compositions, in particular ABS molding compositions or ASA molding compositions, can be significantly increased if the elastomeric particulate emulsion polymers present in the molding compositions are filtered to remove coagulated material prior to incorporation into the molding compositions.

According to the invention, it has been found that inadequacies in the elongation at break of ABS polymers or of ASA polymers can be a result of specks present within the ABS or ASA and at which cracks initiate under tensile load. It has also been found that the fatigue performance of the molding compositions or moldings can be adversely affected by specks.

The invention therefore provides the present process, which can markedly reduce or suppress the formation of specks in ABS molding compositions and in ASA molding compositions, giving particularly advantageous mechanical properties, in particular improved elongation at break of the moldings.

The filtration of graft rubber dispersions is known per se and is usually used to remove coagulated material.

U.S. Pat. No. 4,064,093, for example, describes a process for preparing graft rubber latices free from coagulated material. Here, the latices are passed through a porous filter bed which comprises agglomerated particles of latex. The filters described therein can also be used according to the invention. Other suitable filters and filtration processes are described in JP-A-10 14 203 and JP-A-00 26 004. The filters described preferably have sizes of from 40 to 500 mesh (from 420 to below 37 μm), for example 60 mesh (250 μm), and, respectively, from 10 to 250 mesh (from 2000 to 53 μm). The known processes for filtering dispersions are not carried out in order to improve the elongation at break of ABS polymers or of ASA polymers.

According to the invention, the invention is preferably carried out in a way which places very little mechanical (sheer) stress on that dispersion of component A obtained from an emulsion polymerization. This can further suppress the formation of coagulated material. The filtration may be carried out in any desired apparatus, but preference is given to filtration with very little mechanical stress or shear stress. The filtration is preferably carried out without using pressure, i.e. there is no use of pressure to press the dispersion through a filtration unit, but is preferably carried out merely with the aid of gravity, for example.

For the filtration it is preferable to use filters with filter sizes of from 5 to 400 mesh, particularly preferably from 30 to 400 mesh. That corresponds to mesh widths of from 4 to 0.037 mm, preferably from 0.59 to 0.037 mm, see also Römpp Chemie Lexikon, Electronic Release, 1995, Georg Thieme Verlag.

Examples of types of filter which can be used advantageously on an industrial scale are bag filters, rotary-cylinder screening machines, horizontal pressure leaf filters, vibrating-cylinder screening machines, vibrating-tumbling screening machines and Atlantic filters with bag insert. The selection of the type of filter depends on the separation limit, the capacity of the system and the sensitivity to shear of the dispersion to be filtered.

The present invention also provides the use, in thermoplastic molding compositions for increasing the elongation at break, of particulate emulsion polymers with a glass transition temperature below 0° C. and with a median particle size of from 50 to 1000 nm, which has been freed from coagulated material by filtration.

Preferred thermoplastic molding compositions used and, respectively, prepared according to the invention are described below.

### Component A

Component A is a particulate emulsion polymer with a glass transition temperature below 0° C. and with a median particle size of from 50 to 1000 nm.

Component A is preferably a graft copolymer made from

a1: from 1 to 99% by weight, preferably from 55 to 80% by weight, in particular from 55 to 65% by weight, of a particulate graft base A1 with a glass transition temperature below 0° C.,

a2: from 1 to 99% by weight, preferably from 20 to 45% by weight, in particular from 35 to 45% by weight, of a graft A2 made from the following monomers, the amounts being based on A2,

a21: from 40 to 100% by weight, preferably from 65 to 85% by weight, of at least one vinyl aromatic monomer, preferably of styrene, of a substituted styrene, or of a (meth)acrylate, or of mixtures of these, in particular of styrene and/or of α-methylstyrene as component A21,

a22: from 0 to 60% by weight, preferably from 15 to 35% by weight, of units of at least one ethylenically unsaturated monomer, preferably of acrylonitrile or of methacrylonitrile, in particular of acrylonitrile as component A22, and

a23: from 0 to 30% by weight of other copolymerizable monomers, as component A23,

where the entirety of components A21, A22 and A23 gives 100% by weight.

The graft A2 here is composed of at least one graft shell, the entire graft copolymer A having a median particle size of from 50 to 1000 nm.

In one embodiment of the invention, component A1 is composed of the following monomers:

a11: from 80 to 100% by weight, preferably from 90 to 100% by weight, of butadiene, of at least one C₁₋₈-alkyl acrylate or of mixtures of these, preferably butadiene, n-butyl acrylate and/or ethylhexyl acrylate, as component A11,

a12: from 0 to 20% by weight, preferably from 0 to 10% by weight, of at least one polyfunctional crosslinking monomer, preferably diallyl phthalate and/or DCPA, as component A12, and

a13: from 0 to 20% by weight of other copolymerizable monomers, e.g. styrene or acrylonitrile, as component A13,

where the entirety of components A11 to A13 gives 100% by weight.

In one embodiment of the invention, the median particle size of component A is from 50 to 800 μm, preferably from 50 to 699 nm.

The median particle size and particle size distribution given are the values determined from the cumulative mass distribution. In all cases, the median particle sizes according to the invention are the ponderal median particle sizes as determined using an analytical ultracentrifuge and the method of W. Scholtan and H. Lange, Kolloid-Z. and Z.-Polymere 250 (1972), pp.782-796. The ultracentrifuge measurement gives the cumulative mass distribution of particle diameters in a specimen. From this it can be deduced what percentage by weight of the particle has a diameter equal to or smaller than a certain value. The median particle diameter, also termed d₅₀of the cumulative mass distribution, is defined as that particle diameter at which 50% by weight of the particles have diameters smaller than the diameter corresponding to the d₅₀. 50% by weight of the particles likewise then have diameters larger than the d₅₀. To characterize the breadth of the particle size distribution of the rubber particles, alongside the d₅₀ (median particle diameter) use is made of the d₁₀ and d₉₀ values arising from the cumulative mass distribution. The d₁₀ and d₉₀ values from the cumulative mass distribution here are defined as for the d₅₀, except that they are based on 10 and, respectively, 90% by weight of the particles. The quotient

$$\frac{{d}_{90} - {d}_{10}}{{d}_{50}} = Q$$

is a measure of the breadth of distribution of particle size. According to the invention, emulsion polymers A which can be used as component A preferably have Q values below 0.5, in particular below 0.35.

The glass transition temperature of the emulsion polymer A, like that of the other components used according to the invention, is determined by DSC (differential scanning calorimetry) to ASTM 3418 (midpoint temperature).

Any of the relevant conventional rubbers may be used as emulsion polymer A, for example in one embodiment of the invention butadiene rubbers, epichlorohydrin rubbers, ethylene-vinyl acetate rubbers, polyethylene chlorosulfone rubbers, silicone rubbers, polyether rubbers, hydrogenated diene rubbers, polyalkenamer rubbers, acrylate rubbers, ethylene-propylene rubbers, ethylene-propylene-diene rubbers, butyl rubbers and fluorinated rubbers. Preference is given to the use of butadiene rubber, acrylate rubber, ethylene-propylene (EP) rubber, ethylene-propylene-diene (EPDM) rubber, in particular butadiene rubber or acrylate rubber.

The acrylate rubbers are preferably alkyl acrylate rubbers made from one or more C₁₋₈-alkyl acrylates, preferably from C₄₋₈-alkyl acrylates, preferably using at least some butyl, hexyl, octyl or 2-ethylhexyl acrylate, in particular n-butyl acrylate and 2-ethylhexyl acrylate.

These rubbers, in particular butadiene rubber and acrylate rubber, contain, incorporated into the polymer, up to 20% by weight of monomers forming hard polymers, for example vinyl acetate, (meth)acrylonitrile, styrene, substituted styrene, methyl methacrylate or vinyl ethers.

In one embodiment of the invention, the acrylate rubbers in particular also contain from 0.01 to 20% by weight, preferably from 0.1 to 5% by weight, of crosslinking, polyfunctional monomers (crosslinking monomers).

Examples of these components A12 are monomers which contain 2 or more copolymerizable double bonds, preferably not conjugated in 1,3 positions.

Examples of suitable crosslinking monomers are divinylbenzene, diallyl maleate, diallyl fumurate, diallyl phthalate, diethyl phthalate, triallyl cyanurate, triallyl isocyanurate, tricyclodecenyl acrylate, dihydrodicyclopentadienyl acrylate, triallyl phosphate, allyl acrylate, allyl methacrylate. Dicyclopentadienyl acrylate (DCPA) has proven to be a particularly useful crosslinking monomer (cf. DE-C 12 60 135).

Examples of suitable silicone rubbers are crosslinked silicone rubbers composed of units of the formulae R₂SiO, RSiO_{3/2}, R₃SiO_{½} and SiO_{2/4}, where R is a monovalent radical. The amount of each siloxane unit here is adjusted so that for each 100 units of the formula R₂SiO there are from 0 to 10 molar units of the formula RSiO_{3/2}, from 0 to 1.5 molar units of R₃SiO_{½}, and from 0 to 3 molar units of SiO_{2/4}. R here may either be a monovalent saturated hydrocarbon radical having from 1 to 18 carbon atoms, phenyl or alkoxy, or a group susceptible to free-radical attack, for example vinyl or mercaptopropyl. It is preferable for at least 80% of all of the radicals R to be methyl, and combinations of methyl and ethyl or phenyl are particularly preferred.

Preferred silicone rubbers incorporate units of groups susceptible to free-radical attack, in particular vinyl, allyl, halo or mercapto groups, preferably in amounts of from 2 to 10 mol %, based on all of the radicals R. They may be prepared as described in EP-A-0 260 558, for example.

### Core-shell Emulsion Polymer A

The emulsion polymer A may also be a polymer built up in two or more stages (having what is known as core-shell morphology). For example, an elastomeric core (T_{g}<0° C.) may be encapsulated by a “hard” shell (polymers with T_{g}>0° C.) or vice versa.

In one particularly preferred embodiment of the invention, the component A is a graft copolymer. The graft copolymers A of the molding compositions of the invention here have a median particle size d₅₀ of from 50 to 1000 nm, preferably from 50 to 600 nm and particularly preferably from 50 to 400 nm. These particle sizes can be achieved by using as graft base A1 for this component A particle sizes of from 50 to 350 nm, preferably from 50 to 300 nm and particularly preferably from 50 to 250 nm.

The graft copolymer A generally has one or more stages, i.e. is a polymer built up from a core and from one or more shells. The polymer is composed of a base (graft core) A1 and of, grafted onto this, one or preferably more than one stages A2, known as grafts or graft shells.

Simple grafting or two or more stepwise grafting processes can be used to apply one or more graft shells onto the rubber particles, and each graft shell here may have a different composition. Polyfunctional crosslinking monomers or monomers containing reactive groups may be grafted on in addition to the other monomers to be grafted (see, for example, EP-A-0 230 282, DE-A 36 01 419, EP-A-0 269 861).

In one preferred embodiment, component A is composed of a graft polymer built up in more than one stage, the grafts generally having been prepared from resin-forming monomers and having glass transition temperatures T_{g} above 30° C., preferably above 50° C. The structure with more than one stage serves, inter alia, to give the rubber particles A (some) compatibility with the thermoplastic B.

One way of preparing graft copolymers A is to graft at least one of the monomers A2 listed below onto at least one of the graft bases or graft core materials A1 listed above. Suitable graft bases A1 for the molding compositions of the invention are any of the polymers described above under emulsion polymers A.

Monomers suitable for forming the graft A2 may, for example, be those selected from the monomers listed below and mixtures of these:

vinyl aromatic monomers, for example styrene and its substituted derivatives, e.g. α-methylstyrene, p-methylstyrene, 3,4-dimethylstyrene, p-tert-butylstyrene, o- and p-divinylbenzene and p-methyl-α-methylstyrene, or C₁-C₈-alkyl (meth)acrylates, such as methyl methacrylate, ethyl methacrylate, methyl acrylate, ethyl acrylate, n-butyl acrylate, sec-butyl acrylate; preference is given to styrene, α-methylstyrene, methyl methacrylate, in particular styrene and/or α-methylstyrene, and to ethylenically unsaturated monomers, such as acrylic or methacrylic compounds, e.g. acrylonitrile, methacrylonitrile, acrylic and methacrylic acids, methyl acrylate, ethyl acrylate, n-propyl acrylate, isopropyl acrylate, n-butyl acrylate, isobutyl acrylate, tert-butyl acrylate, 2-ethylhexyl acrylate, methyl methacrylate, ethyl methacrylate, n-propyl methacrylate, isopropyl methacrylate, n-butyl methacrylate, isobutyl methacrylate, tert-butyl methacrylate, cyclohexyl methacrylate, isobornyl methacrylate, maleic anhydride and its derivatives, such as maleic esters, maleic diesters and maleimides, e.g. alkyl- and arylmaleimides, such as methyl- and phenylmaleimide. Preference is given to acrylonitrile and methacrylonitrile, in particular acrylonitrile.

Other (co)monomers which may be used are styrene compounds, vinyl compounds, acrylic compounds and methacrylic compounds (e.g. styrene, if desired substituted with C₁₋₁₂-alkyl radicals, with halogen atoms or with halomethylene radicals; vinylnaphthalene, vinylcarbazole; vinyl ethers having C₁₋₁₂ ether radicals; vinylimidazole, 3-(4-)-vinylpyridine, dimethylaminoethyl (meth)acrylate, p-dimethylaminostyrene, acrylonitrile, methacrylonitrile, acrylic acid, methacrylic acid, butyl acrylate, ethylhexyl acrylate and methyl methacrylate, and also fumaric acid, maleic acid, itaconic acid and their derivative anhydrides, amides, nitriles and esters with alcohols containing from 1 to 22 carbon atoms, preferably from 1 to 10 carbon atoms).

In one embodiment of the invention, component A contains from 50 to 90% by weight of the graft base A1 described above and from 10 to 50% by weight of the graft A2 described above, based on the total weight of component A.

In one embodiment of the invention, butadiene polymers or crosslinked acrylate polymers with a glass transition temperature below 0° C. serve as graft base A1. The butadiene polymers or crosslinked acrylate polymers should preferably have a glass transition temperature below−20° C., in particular below−30° C.

In one preferred embodiment, the graft A2 is composed of at least one graft shell, and the outermost graft shell here has a glass transition temperature above 30° C., where a polymer formed from the monomers of the graft A2 would have a glass transition temperature above 80° C.

What has been said concerning the emulsion polymers A in relation to the measurement of glass transition temperature and of the median particle size, and also of the Q values, also applies to the graft copolymers A.

The graft copolymers A may also be prepared by grafting previously formed polymers onto suitable graft homopolymers. Examples of such instances are the reaction products of copolymers containing maleic anhydride groups or containing acid groups with rubbers containing bases.

Suitable production processes for graft copolymers A are emulsion, solution, bulk and suspension polymerization. The graft copolymers A are preferably prepared by free-radical emulsion polymerization, in particular in the presence of lattices of component A1, at from 20 to 90° C., using water-soluble or oil-soluble initiators, such as peroxodisulfate or benzoyl peroxide, or with the aid of redox initiators. Redox initiators are also suitable for polymerization below 20° C.

Suitable emulsion polymerization processes are described in DE-A-28 26 925, 31 49 358 and DE-A-12 60 135.

The graft shells are preferably built up by the emulsion polymerization process described in DE-A-32 27 555, 3149 357, 31 49 358 and 34 14 118. The processes used for controlling the particle sizes of the invention, from 50 to 1000 nm, are preferably those described in DE-A-12 60 135 and DE-A-28 26 925, or, respectively, Applied Polymer Science, Vol. 9 (1965), p. 2929. The use of polymers with different particle sizes is known from DE-A-28 26 925 and U.S. Pat. No. 5,196,480, for example.

As in the process described in DE-A-12 60 135, the graft base A1 is first prepared by polymerizing the acrylate(s) used in one embodiment of the invention and the polyfunctional, crosslinking monomer, where appropriate together with the other comonomers, in aqueous emulsion in a manner known per se at from 20 to 100° C., preferably from 50 to 80° C. Use may be made of the usual emulsifiers, such as alkali metal salts of alkyl- or alkylarylsulfonic acids, alkyl sulfates, fatty alcohol sulfonates, salts of higher fatty acids having from 10 to 30 carbon atoms, or resin soaps. It is preferable to use the alkali metal salts of alkylsulfonates or fatty acids having from 10 to 18 carbon atoms. In one embodiment, the amount used of the emulsifiers, based on the monomers used in preparing the graft base A1, is from 0.5 to 5% by weight, in particular from 0.5 to 3% by weight. The weight ratio used of water to monomers is usually from 2:1 to 0.7:1. The polymerization initiators used are in particular the commonly used persulfates, such as potassium persulfate. However, it is also possible to use redox systems. The amounts generally used of the initiators are from 0.1 to 1% by weight, based on the monomers used in preparing the graft base A1. Other polymerization auxiliaries which may be used in the polymerization are the usual buffer substances, such as sodium bicarbonate and sodium pyrophosphate, and also from 0 to 3% by weight of a molecular weight regulator, such as mercaptans, terpinols or dimeric α-methylstyrene.

The detailed precise polymerization conditions, in particular the nature, method of feeding and amount of the emulsifier, are determined within the ranges given above in such a way that the resultant latex of the crosslinked acrylate polymer has a d₅₀ within the range from about 50 to 1000 μm, preferably from 50 to 150 nm, particularly preferably within the range from 80 to 100 nm. The particle size distribution of the latex here should preferably be narrow.

Q should be<0.5, preferably<0.35.

In one embodiment of the invention, to prepare the graft polymer A the next step is then to polymerize a monomer mixture made from styrene and acrylonitrile in the presence of the resultant latex of the crosslinked acrylate polymer, the desired weight ratio of styrene to acrylonitrile in the monomer mixture in one embodiment of the invention being within the range from 100:0 to 40:60, preferably within the range from 65:35 to 85:15. It is advantageous for this graft copolymerization of styrene and acrylonitrile onto the crosslinked polyacrylate polymer serving as graft base again to be carried out in aqueous emulsion under the conventional conditions described above. The graft copolymerization can usefully take place in the system used for the emulsion polymerization to prepare the graft base A1, and further emulsifier and initiator may be added if necessary. In one embodiment of the invention, the monomer mixture to be grafted on, made from styrene and acrylonitrile, can be added to the reaction mixture all at once, in portions in two or more stages, or preferably continuously during the polymerization. The manner of conducting the graft copolymerization of the mixture of styrene and acrylonitrile in the presence of the crosslinking acrylate polymer is such as to give the graft copolymer A a degree of grafting of from 1 to 99% by weight, preferably from 20 to 45% by weight, in particular from 35 to 45% by weight, based on the total weight of component A. The degree of grafting gives the proportion by weight of the graft shell in the entire graft copolymer. Since the grafting yield during the graft copolymerization is not 100%, the monomer mixture made from styrene and acrylonitrile has to be used in the graft copolymerization in somewhat greater amounts than the amount corresponding to the desired degree of grafting. The control of the grafting yield in the graft copolymerization, and therefore of the degree of grafting in the finished graft copolymer A, is familiar to the skilled worker and may take place, inter alia, by varying the metering rate of the monomers, or by adding regulator (Chauvel, Daniel, ACS Polymer Preprints 15 (1974), p. 329 et seq.). The emulsion graft copolymerization generally produces from about 5 to 15% by weight, based on the graft copolymer, of free ungrafted styrene-acrylonitrile copolymer. The proportion of the graft copolymer A in the polymerization product obtained during the graft copolymerization is determined by the method given above.

Preparing the graft copolymers A by the emulsion process permits reproducible particle size changes to be obtained, as well as the process advantages stated, for example by at least partial agglomeration of the graft base particles to give larger particle sizes to be present in the graft copolymers A.

It is possible to optimize in particular component A, made from graft base and graft shell(s), for a particular application, especially in relation to particle size.

The graft copolymers A generally contain from 1 to 99% by weight, preferably from 55 to 80% by weight and particularly preferably from 55 to 65% by weight, of graft base A1, and from 1 to 99% by weight, preferably from 20 to 45% by weight, particularly preferably from 35 to 45% by weight, of the graft A2, based in each case on the entire graft copolymer.

### Component B

Component B is an amorphous or semicrystalline polymer.

Component B is preferably a copolymer made from

b1: from 40 to 99% by weight, preferably from 60 to 80% by weight, of units of a vinyl aromatic monomer, preferably of styrene or of a substituted styrene or of a (meth)acrylate, or mixtures of these, in particular of styrene and/or of α-methylstyrene, as component B 1,

b2: from 1 to 60% by weight, preferably from 20 to 40% by weight, of units of an ethylenically unsaturated monomer, preferably of acrylonitrile or of methacrylonitrile, in particular of acrylonitrile, as component B2.

The amorphous or semicrystalline polymers of component B of the molding composition are preferably at least one polymer selected from semicrystalline polyamides, partly aromatic copolyamides, polyolefins, ionomers, polyesters, polyether ketones, polyoxyalkylenes, polyarylene sulfides and polymers made from vinylaromatic monomers and/or from ethylenically unsaturated monomers. It is also possible to use polymer mixtures (see also DE-A-196 30 061).

Component B is preferably an amorphous polymer, as described above as graft A2. In one embodiment of the invention, a copolymer of styrene and/or α-methylstyrene with acrylonitrile is used as component B. The acrylonitrile content in these copolymers of component B is from 0 to 60% by weight, preferably from 20 to 40% by weight, based on the total weight of component B. The free, ungrafted styrene-acrylonitrile copolymers produced during the graft copolymerization to prepare component A also count as part of component B. Depending on the conditions selected during the graft copolymerization to prepare the graft copolymer A, it may be possible for a sufficient proportion of component B to have been formed before the end of the graft copolymerization. However, it will generally be necessary to blend the products obtained during the graft copolymerization with additional, separately prepared component B.

This additional, separately prepared component B may preferably be a styrene-acrylonitrile copolymer, an α-methylstyrene-acrylonitrile copolymer or an α-methylstyrene-styrene-acrylonitrile terpolymer. These copolymers may be used individually or as a mixture for component B, and an example of the additional, separately prepared component B, of the molding compositions used according to the invention is therefore a mixture made from a styrene-acrylonitrile copolymer and from an α-methylstyrene-acrylonitrile copolymer. In the event that component B of the molding compositions used according to the invention is composed of a mixture made from a styrene-acrylonitrile copolymer and from an α-methylstyrene-acrylonitrile copolymer, the acrylonitrile contents of the two copolymers should not differ by more than 10% by weight, preferably not more than 5% by weight, based on the total weight of the copolymer. However, component B of the molding compositions used according to the invention may also be composed of just one single styrene-acrylonitrile copolymer if the same monomer mixture made from styrene and acrylonitrile is used as starting material in the graft copolymerization to prepare component A and also in the preparation of the additional, separately prepared component B.

The additional, separately prepared component B may be obtained by the conventional processes. For example, in one embodiment of the invention, the copolymerization of styrene and/or of α-methylstyrene with the acrylonitrile may be carried out in bulk, solution, suspension or aqueous emulsion. Component B preferably has a viscosity number of from 40 to 100, with preference from 50 to 90, in particular from 60 to 80. The viscosity number here is determined to DIN 53 726, dissolving 0.5 g of material in 100 ml of dimethylformamide.

Components A and B and, where appropriate, C and D may be mixed in any desired manner by any desired method. If, for example, components A and B have been prepared by emulsion polymerization, it is possible for the polymer dispersions obtained to be mixed with one another, and then the polymers to be precipitated together and the polymer mixture to be worked up. However, components A and B are preferably blended by joint extrusion, kneading or roll-milling of the components, the components having been isolated if necessary in advance from the solution or aqueous dispersion obtained during the polymerization. It is also possible for the products obtained in aqueous dispersion from the graft copolymerization (component A) to be only partially dewatered and to be in moist crumb form when mixed with component B, the complete drying of the graft copolymers then taking place during the mixing process.

In one preferred embodiment, the molding compositions comprise, besides components A and B, additional components C and/or D, and also, where appropriate, other additives, as described below.

### Component C

Other thermoplastic polymers such as polyamides or polycarbonates are used as component C.

Suitable polycarbonates C are known per se. They preferably have a molar mass (weight-average M_{w}, determined by gel permeation chromatography in tetrahydrofuran against polystyrene standards) within the range from 10 000 to 60 000 g/mol. They can be obtained, for example, by the processes of DE-B-1 300 266 by interfacial polycondensation, or by the process of DE-A-1 495 730, by reacting diphenyl carbonate with bisphenols. Preferred bisphenol is 2,2-di(4-hydroxyphenyl)propane, generally—and hereinafter—termed bisphenol A.

Instead of bisphenol A it is also possible to use other aromatic dihydroxy compounds, in particular 2,2-di(4-hydroxyphenyl)pentane, 2,6-dihydroxynaphthalene, 4,4′-dihydroxydiphenyl sulfone, 4,4′-dihydroxydiphenyl ether, 4,4′-dihydroxydiphenyl sulfite, 4,4′-dihydroxydiphenylmethane, 1,1-di(4-hydroxyphenyl)ethane, 4,4-dihydroxybiphenyl or dihydroxydiphenylcycloalkanes, preferably dihydroxydiphenylcyclohexanes or dihydroxycyclopentanes, in particular 1,1-bis(4-hydroxyphenyl)-3,3,5-trimethylcyclohexane, or else mixtures of the abovementioned dihydroxy compounds.

Particularly preferred polycarbonates are those prepared from bisphenol A or from bisphenol A together with up to 80 mol % of the abovementioned aromatic dihydroxy compounds.

It is also possible to use copolycarbonates as in U.S. Pat. No. 3,737,409. Of particular interest here are copolycarbonates prepared from bisphenol A and di-(3,5-dimethyldihydroxyphenyl) sulfone, these having high heat resistance. It is also possible to use mixtures of different polycarbonates.

According to the invention, the average molar masses (weight-average M_{w}, determined by gel permeation chromatography in tetrahydrofuran against polystyrene standards) of the polycarbonates C are within the range from 10 000 to 64 000 g/mol. They are preferably within the range from 15 000 to 63 000 g/mol, in particular within the range from 15 000 to 60 000 g/mol. This means that the polycarbonates C have relative solution viscosities within the range from 1.1 to 1.3, measured in 0.5% strength by weight solution in dichloromethane at 25° C., preferably from 1.15 to 1.33. The difference between the relative solution viscosities of the polycarbonates used is preferably not more than 0.05, in particular not more than 0.04.

The polycarbonates C may be used either as regrind or else as pellets. They are present as component C in amounts of from 0 to 50% by weight, preferably from 10 to 40% by weight, based in each case on the entire molding composition.

The addition of polycarbonates leads, inter alia, to greater heat resistance and improved cracking resistance in the molding compositions.

Other suitable thermoplastic polymers are known.

### Component D

As component D, the thermoplastic molding compositions comprise from 0 to 50% by weight, preferably from 0 to 40% by weight, in particular from 0 to 30% by weight, of fibrous or particulate fillers or mixers of these, based in each case on the entire molding composition. These are preferably commercially available products.

Reinforcing agents, such as carbon fibers and glass fibers, are usually used in amounts of from 5 to 50% by weight, based on the entire molding composition.

The glass fibers used may be composed of E, A or C glass, and have preferably been provided with a size and with a coupling agent. Their diameter is generally from 6 to 20 μm. Use may be made either of continuous-filament fibers (rovings) or else of chopped glass fibers (staple) with a length of from 1 to 10 μm, preferably from 3 to 6 μm.

Fillers or reinforcing materials such as glass beads, mineral fibers, whiskers, aluminum oxide fibers, mica, powdered quartz and wollastonite may also be added.

Metal flakes (e.g. aluminum flakes from Transmet Corp.), metal powders, metal fibers, metal-coated fillers, e.g. nickel-coated glass fibers, and also other additives which screen off electromagnetic waves, may also be admixed with the molding compositions used according to the invention to produce the housings of the invention. In particular, use may be made of aluminum flakes (K 102 from Transmet) for EMI (electromagnetic interference) purposes. The compositions may also be mixed with additional carbon fibers, carbon black, in particular conductivity black, or nickel-coated carbon fibers.

The molding compositions used according to the invention may moreover comprise other additives typically and commonly used for polycarbonates, SAN polymers or graft copolymers or mixtures of these. Examples of additives of this type are: dyes, pigments, colorants, antistats, antioxidants, stabilizers to improve heat resistance, to increase lightfastness, or to raise hydrolysis resistance and chemicals resistance, agents to inhibit thermal decomposition, and in particular lubricants, which are useful for producing moldings. These other additives may be metered in at any stage of the preparation or production process, but preferably at an early juncture, in order to make early use of their stabilizing effects (or other specific effects).

Suitable stabilizers are the usual hindered phenols, and also vitamin E and compounds of similar structure. Other suitable stabilizers are HALS stabilizers (hindered amine light stabilizers), benzophenones, resorcinols, salicylates, benzotriazoles and other compounds (for example Irganox®, Tinuvin®, such as Tinuvin® 770 (HALS absorber, bis(2,2,6,6-tetramethyl-4-piperidyl) sebazate) or Tinuvin® P (UV absorber—(2H-benzotriazol-2-yl)-4-methylphenol, Topanol®). These are usually used in amounts of up to 2% by weight (based on the entire mixture).

Suitable lubricants and mold-release agents are stearic acids, stearyl alcohol, stearic esters, and in general higher fatty acids, derivatives of these and corresponding fatty acid mixtures having from 12 to 30 carbon atoms. The amounts of these additives are within the range from 0.05 to 1% by weight.

Other additives which may be used are silicone oils, oligomeric isobutylene and similar substances, the usual amounts being from 0.05 to 5% by weight. It is also possible to use pigments, dyes, color brighteners, such as ultramarine blue, phthalocyanines, titanium dioxide, cadmium sulfides, and derivatives of perylenetetracarboxylic acid.

Processing aids and stabilizers, such as UV stabilizers, lubricants and antistats, are usually used in amounts of from 0.01 to 5% by weight, based on the entire molding composition.

The thermoplastic molding compositions may be prepared by processes known per se, by mixing the components. It may be advantageous to premix individual components.

Examples of suitable organic solvents are chlorobenzene, mixtures made from chlorobenzene and methylene chloride, and mixtures made from chlorobenzene or from aromatic hydrocarbons, e.g. toluene.

The concentration of the solvent mixtures by evaporation may take place in vented extruders, for example.

The components, for example the dry components, may be mixed by any known method. However, the mixing preferably takes place by extruding, kneading or roll-milling the components together, preferably at from 180 to 400° C., the components having been isolated in advance if necessary from the solution or aqueous dispersion obtained during the polymerization.

The components here may be metered in together or separately/in succession.

Moldings, or fibers or films, may be produced from the thermoplastic molding compositions used according to the invention by known thermoplastic processing methods. In particular, they may be produced by thermoforming, extrusion, injection molding, calendering, blow molding, compression molding, sintering or pressure sintering, preferably by injection molding.

The examples below provide further illustration of the invention:

### EXAMPLES

### Example 1

The graft monomers styrene and acrylonitrile, and initiator, were added to a dispersion of a polybutadiene latex (ponderal median d₅₀of the particle size distribution as given by an ultracentrifuge: 300 nm), and polymerized to completion. Molding compositions 1 and 2 differ in the compositions of their graft shells.

The resultant graft dispersion was then filtered with the aid of metal filters of different mesh sizes. The graft rubber was then precipitated by adding electrolyte solution, and isolated. The isolated graft rubber was then compounded with poly(styrene-co-acrylonitrile) in an extruder. The resultant ABS molding compositions 1 and 2 were then pelletized, injection molded to give test specimens and tested mechanically.

### Example 2

An agglomerating agent, followed by the graft monomers styrene and acrylonitrile, and initiator, were added to a dispersion of a polybutadiene latex (ponderal median d₅₀ of the particle size distribution as given by an ultracentrifuge: 100 nm), and polymerized to completion (molding composition 3).

The resultant graft dispersion was then filtered with the aid of metal filters of different mesh sizes. The graft rubber was then precipitated by adding electrolyte solution, and isolated. The isolated graft rubber was then compounded with poly(styrene-co-acrylonitrile) in an extruder. The resultant ABS molding composition 3 was then pelletized, injection molded to give test specimens and tested mechanically.

The mechanical properties of the molding compositions are given in Tables 1 and 2 below. The methods used to measure the various parameters are given.

TABLE 1
Effect of filter size on mechanical properties

| | | | | | Min. | Max. | |
|---|---|---|---|---|---|---|---|
| | | | Elonga- | Stan- | elonga- | elonga- | |
| Molding | Filter | Speck | tion at | dard | tion at | tion at | |
| compo- | size | count | break | devia- | break | break | |
| sition | (μm) | (%) | (%) | tion | (%) | (%) | Izod |
| 1 | — | — | 10.1 | 2.7 | 7.6 | 14.4 | 33.4 |
| 1 | 250 | 0.23 | 32.3 | 14.6 | 24 | 53 | 33.4 |
| 1 | 40 | 0.3 | 32.4 | 18 | 14.8 | 60.1 | 30.8 |
| 2 | — | 8.1 | 3.2 | 3.8 | 12.3 | 22.5 | 22.5 |
| 2 | 250 | 0.12 | 21.8 | 4.1 | 23.5 | 36.9 | 23.1 |
| 2 | 40 | 0.18 | 30.3 | 4.8 | 23.5 | 36.9 | 23.1 |

TABLE 2
Effect of filter size on mechanical properties

| Molding | Filter | | Modulus | | | an | | ak | ak | Vicat | Vicat | MVR |
|---|---|---|---|---|---|---|---|---|---|---|---|---|
| compo- | size | Rubber | of elasticity | YS | EB | −40 | an_{RT} | −40 | RT | A | B | 220/10 |
| sition | μm | % | MPa | MPa | % | kJ/m² | kJ/m² | kJ/m² | kJ/m² | ° C. | ° C. | ml/10 min |
| 3 | | 29.7 | 2379 | 49.9 | 14.9 | 80 | 83.33 | 6.42 | 15.56 | 103.3 | 94.8 | 16.2 |
| 3 | 1000 | 34.8 | 2244 | 47.9 | 20.8 | 80.56 | no | 7.47 | 14.75 | 107.3 | 97.7 | 9.2 |
| | | | | | | | fracture | | | | | |
| 3 | 400 | 33.7 | 2130 | 46.7 | 22 | 110.4 | no | 7.22 | 14.32 | 107.4 | 98 | 10.8 |
| | | | | | | | fracture | | | | | |
| 3 | 250 | 31 | 2102 | 46.4 | 21.8 | 91.44 | no | 6.79 | 13.46 | 107.5 | 98.4 | 13.1 |
| | | | | | | | fracture | | | | | |
| 3 | 125 | 35.8 | 2042 | 45.5 | 21.7 | 97.92 | no | 7.16 | 14.26 | 107.4 | 97.2 | 8.4 |
| | | | | | | | fracture | | | | | |

YS: Yield stress

EB: Elongation at break

an: Impact strength

ak: Notched impact strength

| Standards: | | |
|---|---|---|
| Tensile test | DIN 53455-3 | Dumbbell |
| | | specimen |
| Tensile modulus of | DIN 53457 | Dumbbell |
| elasticity | | specimen |
| Flexural impact test | DIN 53453-n | Standard small |
| | | specimen |
| | | Thickness 4.00 mm |
| | | Width 6.00 mm |
| Flexural impact test | DIN 53453-k | Standard small |
| | | specimen |
| (notched impact strength) | Milled notch | |
| Vicat A/50 and B/50 | DIN 53460 | Standard small |
| | | specimen |
| Izod | ISO 180/1A | |

We claim:

1. A process for increasing the elongation at break of moldings made from thermoplastic molding compositions comprising, based on the total of the amounts of components A and B and, where appropriate C and/or D, the entirety of which gives 100% by weight,
a: from 1 to 99% by weight of a particulate emulsion polymer with a glass transition temperature below 0° C. and with a median particle size of from 50 to 1000 nm, as component A,
b: from 1 to 99% by weight of at least one amorphous or semicrystalline polymer, as component B,
c: from 0 to 50% by weight of other thermoplastic polymers, as component C, and
d: from 0 to 50% by weight of fibrous or particulate fillers or mixtures of these, as component D,
which comprises filtering that dispersion of component A obtained from an emulsion polymerization, to remove coagulated material, and then further processing the dispersion to give the thermoplastic molding composition.

2. A process as claimed in claim 1, wherein filters with filter sizes of from 5 to 400 mesh are used for the filtration.

3. A process as claimed in claim 1, wherein the filtration is not carried out using pressure.

4. A process as claimed in claim 1, wherein bag filters, rotary-cylinder screening machines, horizontal pressure leaf filters, vibrating-cylinder screening machines, vibrating-tumbling screening machines or Atlantic filters with bag insert are used for the filtration.

5. A process as claimed in claim 1, wherein component A is a graft copolymer made from
a1: from 1 to 99% by weight of a particulate graft base A1 with a glass transition temperature below 0° C.,
a2: from 1 to 99% by weight of a graft A2 made from the following monomers, the amounts being based on A2,
a21: from 40 to 100% by weight of at least one vinyl aromatic monomer, as component A21,
a22: from 0 to 60% by weight of units of at least one ethylenically unsaturated monomer, as component A22, and
a23: from 0 to 30% by weight of other copolymerizable monomers, as component A23,
where the entirety of components A21, A22 and A23 gives 100% by weight,
and where the graft A2 is composed of at least one graft shell and the graft copolymer A has a median particle size of from 50 to 1000 nm.

6. A process as claimed in claim 5, wherein the molding composition comprises a butadiene rubber, acrylate rubber, EPDM rubber or silicone rubber, as particulate graft base A1.

7. A process as claimed in claim 6, wherein component A1 is composed of the following monomers:
a11: from 80 to 100% by weight of butadiene, of at least one C₁₋₈-alkyl acrylate or of mixtures of these, as component A1,
a12: from 0 to 20% by weight of at least one polyfunctional crosslinking monomer, as component A12, and
a13: from 0 to 20% by weight of other copolymerizable monomers, as component A13,
where the entirety of components A11 to A13 gives 100% by weight.
